(19) United States
(12) Patent Application Publication
(10) Pub. No.: US 2010/0283942 A1
(43) Pub. Date: Nov. 11, 2010

(54) ILLUMINATING DEVICE AND LIQUID CRYSTAL DISPLAY DEVICE

(76) Inventors: Takehiro Murao, Osaka (JP); Naru Usukura, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/810,946

(22) PCT Filed: Dec. 19, 2008
(86) PCT No.: PCT/JP2008/003865

§ 371 Date: Jun. 28, 2010

(30) Foreign Application Priority Data
Dec. 28, 2007 (JP) 2007-340998

(51) Int. Cl. G02F 1/13357; F21V 7/22

(52) U.S. Cl. 349/64; 362/606

(57) ABSTRACT

An illuminator 10 according to the present invention includes a plurality of light sources 14 for emitting light, a light guide plate 12 for propagating the emitted light, and an anisotropic diffusion plate 11 disposed in at least a portion of the light guide plate 12 closer to the light sources 14, the anisotropic diffusion plate 11 diffusing light propagating through the light guide plate 12. Regarding in-plane directions of the light guide plate 12, the anisotropic diffusion plate 11 diffuses light more along a direction which is parallel to an arraying direction of the plurality of light sources 14 than along a direction perpendicular thereto. As a result, while suppressing spread of a half-luminance angle of light, appearance of an image can be improved, and also lowering of luminance caused by diffusion can be suppressed.

### TECHNICAL FIELD

The present invention relates to an illuminator and a liquid crystal display device.

### BACKGROUND ART

In recent years, liquid crystal display devices are widely used as display devices of monitors, projectors, mobile information terminals, mobile phones, and the like. Generally speaking, a liquid crystal display device allows the transmittance (or reflectance) of a liquid crystal display panel to vary with a driving signal, thus modulating the intensity of light from a light source which is radiated onto the liquid crystal display panel, whereby images or text is displayed. Liquid crystal display devices include: the direct-viewing type display device, in which images and the like which are displayed on a liquid crystal display panel are to be viewed directly; the projection-type display device (projector), in which images and the like which are displayed on a liquid crystal display panel are projected by projection lens onto a screen in an enlarged size; and so on.

By applying a driving voltage corresponding to an image signal to each of the pixels which are regularly arrayed in a matrix shape, a liquid crystal display device allows the optical characteristics of a liquid crystal layer to vary in each pixel, and with polarizers (which typically are polarizing plates) being placed in the front and the rear, regulates transmitted light in accordance with the optical characteristics of the liquid crystal layer, thereby displaying images, text, and the like. In a direct-viewing type liquid crystal display device, these polarizing plates are usually directly attached respectively to a light-incident-side substrate (rear substrate) and a light-outgoing-side substrate (front substrate or viewer-side substrate) of the liquid crystal display panel.

Methods for applying independent driving voltages to the respective pixels include the passive matrix method and the active matrix method. Among these, in a liquid crystal display panel according to the active matrix method, switching elements and wiring lines for supplying driving voltages to pixel electrodes need to be provided. As the switching elements, non-linear 2-terminal devices such as MIM (metal-insulator-metal) devices and 3-terminal devices such as TFT (thin film transistor) devices are being used.

It is known that light emitted from a backlight of a liquid crystal display device suffers unevenness due to factors of various constituent elements such as the light source, light guide plate, prism sheet, and the like. A method of reducing such unevenness of light is a method of diffusing light by using a diffusion sheet (see, for example, Patent Document 1).

With reference to FIG. 10, a construction for diffusing light by using a diffusion sheet will be described. FIG. 10 is a diagram showing an illuminator to be mounted in a liquid crystal display device. The illuminator includes a diffusion sheet 119 for diffusing light. While propagating through a light guide plate 112, light which is emitted from light sources 114 is reflected by a reflector 116, and passes through the light guide plate 112 and a prism sheet 118 to enter a liquid crystal panel (not shown). Light entering the liquid crystal panel is diffused when passing through the diffusion sheet 119, whereby unevenness of light can be reduced.

[Patent Document 1] Japanese Laid-Open Patent Publication No. 2007-134281

### DISCLOSURE OF INVENTION

### Problems to be Solved by the Invention

In a liquid crystal display device for mobile applications, due to market requirements for a thinner and downsized module, there has been a trend to adopt an edge light type backlight having LEDs (Light Emitting Diodes) as light-emitting devices.

In a backlight having LEDs, an eyeball-like unevenness due to light distribution characteristics of the LEDs occurs near a light-incident portion, thus resulting in a deteriorated appearance. This problem is particularly outstanding in the case of a reverse prism type backlight.

FIG. 11 is a diagram showing an eyeball-like unevenness. Due to the light distribution characteristics of the light sources (LEDs) 114, dark portions 113 are created in between LEDs 114, and bright portions 115 are created in front of the LEDs 114. When such regions containing the diversely-present dark portions 113 and bright portions 115 reach a displaying region 110, bright-and-dark portions (eyeball-like unevenness) are visually recognized in the displaying region.

One method for reducing such eyeball-like unevenness may be a method of elongating a distance (runway) 117 from the LEDs to an active area. However, increasing the runway 117 will enlarge the outer shape of the backlight, and thus is not suitable for downsizing the module.

In order to effectively utilize light from a backlight of a liquid crystal display device, adoption of a microlens array (MLA) is being considered. As a backlight for a microlens array, it is desirable to use a backlight having a narrow half-luminance angle in order to enhance the light converging effect of the lenses, and thus a reverse prism type (TL type) backlight is used to narrow the half-luminance angle along the lens curvature direction. Therefore, merely employing a diffusion sheet for diffusing light will increase the half-luminance angle, and thus reduce the effect of the microlens array. Moreover, presence of a diffusion sheet all over the displaying region is a factor leading to a lowered luminance.

The present invention has been made in view of the above problems, and provides an illuminator and liquid crystal display device which improves appearance while suppressing spread of a half-luminance angle of light, and also reduces lowering of luminance caused by diffusion.

### Means for Solving the Problems

An illuminator according to the present invention comprises: a plurality of light sources for emitting light; a light guide plate for propagating the emitted light; and anisotropic diffusion particles disposed on at least a portion of the light guide plate closer to the light sources, the anisotropic diffusion particles diffusing light propagating through the light guide plate, characterized in that regarding in-plane directions of the light guide plate, the anisotropic diffusion particles diffuses the light more along a direction which is parallel to an arraying direction of the plurality of light sources than along a perpendicular direction thereto.

In one embodiment, the anisotropic diffusion particles are disposed in at least a portion of a region extending from a light-source end of the light guide plate to a position corresponding to an image displaying region.

One embodiment further comprises a reflector for reflecting light propagating through the light guide plate, wherein the anisotropic diffusion particles are disposed on a face of the light guide plate facing the reflector.

In one embodiment, the anisotropic diffusion particles are disposed on an outgoing face side of the light guide plate.

In one embodiment, a light-source end of the light guide plate has a thickness which is thicker than a thickness of a position of the light guide plate corresponding to an image displaying region; the light guide plate has a tapered portion whose thickness becomes gradually thinner from the light-source end toward the position corresponding to the image displaying region; and the anisotropic diffusion particles are disposed on the tapered portion.

One embodiment further comprises an anisotropic diffusion plate disposed in a portion of the light guide plate closer to the light sources, wherein the anisotropic diffusion particles are contained in the anisotropic diffusion plate.

In one embodiment, the illuminator is a reverse prism type backlight.

A liquid crystal display device according to the present invention is characterized by comprising: the aforementioned illuminator; and a liquid crystal panel having a pair of substrates and a liquid crystal layer interposed between the pair of substrates.

One embodiment further comprises a plurality of microlenses provided between the liquid crystal panel and the illuminator.

### EFFECTS OF THE INVENTION

According to the present invention, anisotropic diffusion particles are disposed on at least a portion of the light guide plate closer to the light sources, and regarding in-plane directions of the light guide plate, the anisotropic diffusion particles diffuse light more along a direction which is parallel to an arraying direction of the plurality of light sources than along a perpendicular direction thereto. As a result, while reducing spread of a half-luminance angle and decrease in luminance, eyeball-like unevenness can be reduced for an improved appearance. Downsizing of the module can also be realized, and thus a liquid crystal display device having a high efficiency and a good display quality can be provided.

### BRIEF DESCRIPTION OF DRAWINGS

FIG. 1 A cross-sectional view showing a liquid crystal display device according to an embodiment of the present invention.

FIG. 2 (a) is a perspective view showing an anisotropic diffusion plate according to an embodiment of the present invention and its surrounding constituent elements; (b) is a perspective view showing enlarged the anisotropic diffusion plate according to an embodiment of the present invention; and (c) is a cross-sectional view showing the anisotropic diffusion plate according to an embodiment of the present invention and its surrounding constituent elements.

FIG. 3 A perspective view showing the anisotropic diffusion plate according to an embodiment of the present invention.

FIG. 4 A diagram showing how anisotropic diffusion particles according to an embodiment of the present invention may diffuse light.

FIG. 5 (a) is a plan view of a light guide plate in which anisotropic diffusion particles are not provided; and (b) is a cross-sectional view of the light guide plate in which anisotropic diffusion particles are not provided.

FIG. 6 (a) is a plan view of a light guide plate in which anisotropic diffusion particles according to an embodiment of the present invention are provided; and (b) is a cross-sectional view of the light guide plate in which anisotropic diffusion particles according to an embodiment of the present invention are provided.

FIG. 7 A diagram showing an anisotropic diffusion plate which is disposed on an outgoing face side of a light guide plate according to an embodiment of the present invention.

FIG. 8 A diagram showing an anisotropic diffusion plate disposed on a light guide plate having a tapered portion according to an embodiment of the present invention.

FIG. 9 A diagram showing an anisotropic diffusion plate disposed on a light guide plate adjoining unpackaged LEDs according to an embodiment of the present invention.

FIG. 10 A diagram showing an illuminator to be mounted in a liquid crystal display device.

FIG. 11 A diagram showing eyeball-like unevenness.

### DESCRIPTION OF REFERENCE NUMERALS

1 liquid crystal display device
10 illuminator
11 anisotropic diffusion plate
12 light guide plate
16 reflector
18 prism sheet
26 prism
31 anisotropic diffusion particle (filler needle)
50 liquid crystal display panel
51 liquid crystal panel
52 microlens array
52a microlens

### BEST MODE FOR CARRYING OUT THE INVENTION

Hereinafter, with reference to the drawings, an embodiment of an illuminator and liquid crystal display device according to the present invention will be described.

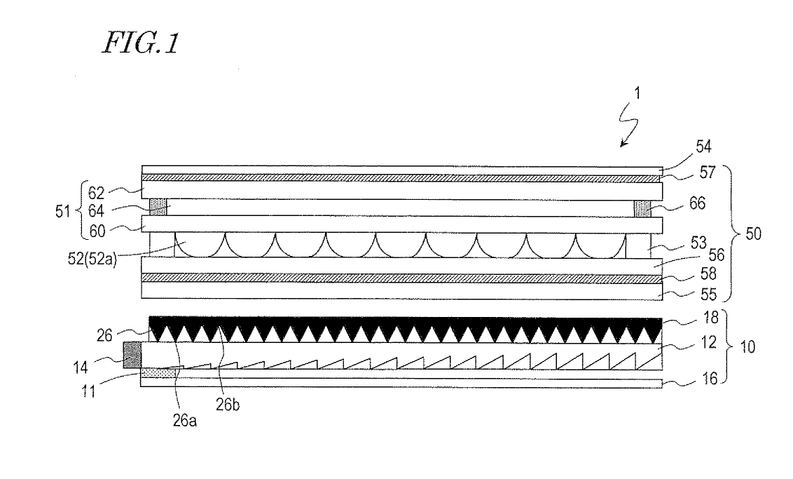

FIG. 1 is a cross-sectional view showing a liquid crystal display device 1 according to an embodiment of the present invention. The liquid crystal display device 1 includes a liquid crystal display panel (liquid crystal panel with microlenses) 50 and an illuminator 10 provided below (on an opposite face from the display surface) the liquid crystal display panel 50.

The illuminator 10 includes a light guide plate 12, LEDs (Light Emitting Diodes) 14 which are light sources provided on one side face of the light guide plate 12, a reflector 16 provided below the light guide plate 12, a prism sheet 18 above (closer to the liquid crystal panel) the light guide plate 12, and an anisotropic diffusion plate 11 provided between the light guide plate 12 and the reflector 16.

A plurality of slopes are formed in a lower portion of the light guide plate 12 facing the reflector 16, such that the plurality of slopes have increasing tilting angles away from the LEDs 14. The positioning of the slopes is exemplary, and the slopes may be provided in an upper portion of the light guide plate 12. Alternatively, the slopes may be formed in a direction which is orthogonal to a light-incident face of the light guide plate 12.

Instead of LEDs 14, cold-cathode tubes may be used as the light sources, and the LEDs 14 may be disposed at corner portions sandwiched between two side faces of the light guide plate 12.

The prism sheet 18 is a prism array including a plurality of prisms 26 arrayed in an arbitrary direction. The illuminator 10 is a backlight of a reverse prism type, each prism 26 having a peak portion 26a which is pointed downward. Valley portions (groove portions) 26b are provided between peak portions 26a.

Light going out from the LEDs 14 propagate through the light guide plate 12, and after being reflected by the reflector 16 or the slopes of the light guide plate 12, travels through an upper face (outgoing face) of the light guide plate 12, and is refracted by the prisms 26 of the prism sheet 18, thus being emitted toward the liquid crystal display panel 50, which is provided above the prism sheet 18. Moreover, the light propagating through the light guide plate 12 is diffused by the anisotropic diffusion plate 11. The detailed functions of the anisotropic diffusion plate 11 will be described later.

The liquid crystal display panel 50 includes: a liquid crystal panel (composite substrate) 51 having a plurality of pixels disposed in a matrix shape; a microlens array 52 including a plurality of microlenses 52a provided on a light-receiving face of the liquid crystal panel 51 (a bottom face of the liquid crystal panel 51 extending perpendicular to the plane of the figure); supports 53 provided in a peripheral region of the microlens array 52; a front-face optical film 54 provided on the viewer side (upper side in the figure) of the liquid crystal panel 51; a rear-face optical film 55 provided on the light-incident side of the microlens array 52; and a protection layer 56 interposed between the rear-face optical film 55 and the microlens array 52. The microlens array 52 is interposed between the liquid crystal panel 51 and the illuminator 10.

The protection layer 56 is composed of a photocurable resin, and is in contact with the microlens array 52 and the supports 53. The protection layer 56 and the microlens array 52 are attached so that the protection layer 56 is only in contact with the neighborhood of the apex of each microlens 52a.

The front-face optical film 54 is attached to the liquid crystal panel 51 via an adhesion layer 57, whereas the rear-face optical film 55 is attached to the protection layer 56 via an adhesion layer 58. Note that each of the front-face optical film 54 and the rear-face optical film 55 has a polarization film which transmits linearly polarized light.

The protection layer 56 is composed of an acryl-type or epoxy-type UV-curing resin having a high transmittance for visible light, but may also be composed of a thermosetting resin. Preferably, the protection layer 56 and the supports 53 are composed of the same material as that of the microlenses 52a, or a material having substantially the same refractive index as the refractive index of the material composing the microlenses 52a.

The liquid crystal panel 51 includes an electrical device substrate 60 on which a switching element (e.g., a TFT or MIM device) is formed for each pixel, a counter substrate 62 which is e.g. a color filter substrate (CF substrate), and a liquid crystal layer 64. The liquid crystal layer 64 includes a liquid crystal material which is contained between the electrical device substrate 60 and the counter substrate 62, and is sealed with a sealant 66 which is provided in the outer periphery.

The microlenses 52a of the microlens array 52 are lenticular lenses extending so as to correspond to columns of pixels provided in a matrix shape on the liquid crystal panel (a perpendicular direction to the plane of the figure). Although depending on the model, the pixel pitch (the width of one pixel) is about 50 to 300 μm, and the width of the microlenses 52a is also a width corresponding to the pixel pitch.

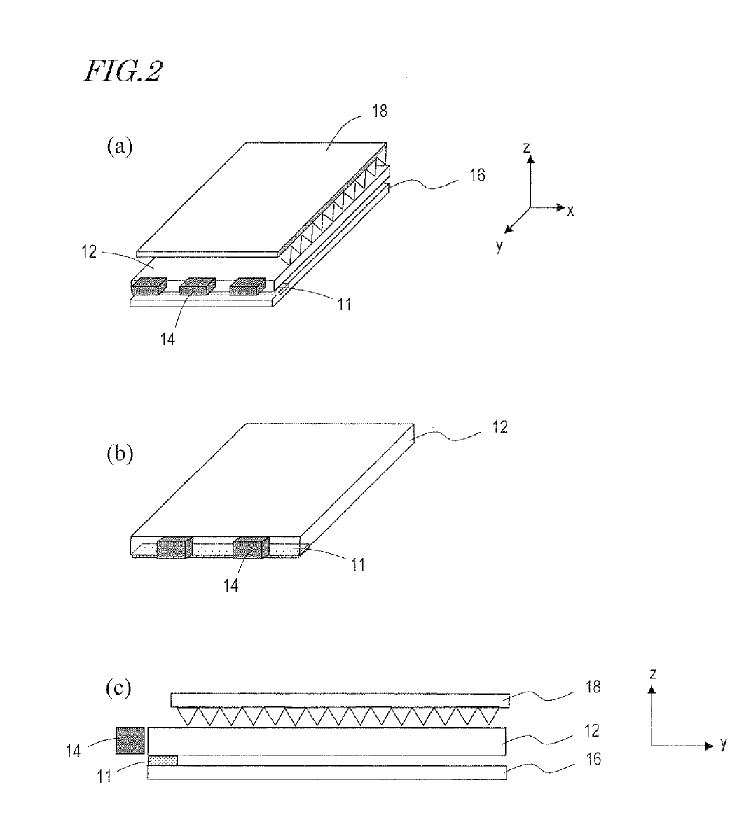

Next, the anisotropic diffusion plate 11 will be described in more detail. FIG. 2(a) is a perspective view showing the anisotropic diffusion plate 11 and its surrounding constituent elements; FIG. 2(b) is a perspective view showing enlarged the anisotropic diffusion plate 11; and FIG. 2(c) is a cross-sectional view showing the anisotropic diffusion plate 11 and its surrounding constituent elements.

The anisotropic diffusion plate 11 is disposed on a portion of the light guide plate 12 closer to the LEDs 14. That is, it is disposed closer to the light sources with respect to the central portion of the light guide plate 12. More preferably, it is disposed in at least a portion of the region (a region to become a runway) extending from the LED 14 end to an active area (a region corresponding to an image displaying region) of the light guide plate 12. Although depending on the size of the display screen, the width of the anisotropic diffusion plate 11 along the y direction is 10 mm or less in the 3 inch class, for example.

The anisotropic diffusion plate 11 is disposed on a face on the rear face (lower side in the figure) side of the light guide plate 12, and is positioned between the light guide plate 12 and the reflector 16. A portion of the light propagating through the light guide plate 12 enters anisotropic diffusion plate 11, and is diffused by the anisotropic diffusion plate 11. This diffused light is reflected by the reflector 16, again passes through the anisotropic diffusion plate 11, and is emitted from the upper face (outgoing face) of the light guide plate 12.

FIG. 3 is a perspective view showing the anisotropic diffusion plate 11. The anisotropic diffusion plate 11 includes a plurality of anisotropic diffusion particles 31 having optical diffusion anisotropy. Regarding in-plane directions (xy directions) of the light guide plate 12, the anisotropic diffusion particles 31 diffuses light more along a direction (x direction) which is parallel to the arraying direction of the plurality of LEDs 14 (x direction) than along a perpendicular direction thereto (y direction).

The anisotropic diffusion particles 31 are filler needles, for example. An anisotropic diffusion plate 11 or a light guide plate 12 in which such filler needles 31 are disposed can be produced by using a tackiness agent in which the filler needles 31 are mixed, for example. It is desirable that the tackiness agent has a high optical transparency; for example, an acryl-type tackiness agent or the like can be used. The main component of the acryl-type tackiness agent may be, for example: a homopolymer of an acrylic monomer such as acrylic acid and its ester, methacrylic acid and its ester, acrylamide, or acrylonitrile, or a copolymer thereof; a copolymer between at least one kind of acrylic monomer and a vinyl monomer such as vinyl acetate, maleic anhydride, styrene, or the like; and so on.

The filler needles 31 are pieces of filler having a different refractive index from that of the tackiness agent and having needle shapes (including fibrous shapes) with a high aspect ratio, and are preferably colorless or white in order to prevent coloration of transmitted light. As the filler needles 31, needle-like or fibrous pieces composed of a metal oxide such as titanium oxide, zirconium oxide, or zinc oxide, a metal compound such as boehmite, aluminum borate, calcium silicate, basic magnesium sulfate, calcium carbonate, or potassium titanate, glass, or a synthetic resin are suitably used, for example. A filler needle 31 is sized so that it has a longer diameter of 2 to 5000 μm and a shorter diameter of 0.1 to 20 μm, for example, and more preferably has a longer diameter of 10 to 300 μm and a shorter diameter of 0.3 to 5 μm.

One method of producing an anisotropic diffusion plate 11 and/or a light guide plate 12 in which the filler needles 31 are disposed may be a method of preparing a filler-containing adhesive composition including filler needles 31 dispersed in a tackiness agent, using this to coat a sheet serving as a base of the anisotropic diffusion plate 11 and/or the light guide plate 12, and thereafter removing the solvent by drying, for example. Furthermore, as necessary, about 1 day or 2 weeks of curing may be performed in a temperature environment at room temperature or about 30 to 60° C., in order to solidify or stabilize the tackiness agent component.

When the filler-containing adhesive composition is used for coating, each filler needle 31 is aligned so that its major axis is substantially along the direction of coating, due to a shearing force which acts on the filler-containing adhesive composition. Thus, it is possible to set the orientations of the filler needles 31 based on the direction of coating. Note that the degree of alignment of the filler needles can be adjusted based on the size of the filler needles, the viscosity of the filler-containing adhesive composition, the coating method, the coating speed, and the like. A filler-containing layer which is composed of a filler-containing adhesive composition has a thickness of 1 to 50 μm, for example, and more preferably 10 to 30 μm.

Alternatively, an anisotropic diffusion plate 11 and/or a light guide plate 12 in which the filler needles 31 are disposed may be produced by mixing the filler needles 31 in an acryl-type or epoxy-type resin which is UV-curing or thermosetting, using such a resin containing the filler needles 31 to coat a sheet serving as a base of the anisotropic diffusion plate 11 and/or the light guide plate 12, and solidifying it by applying ultraviolet or heat. In this case, too, it is possible to set the orientations of the filler needles 31 based on the direction of coating.

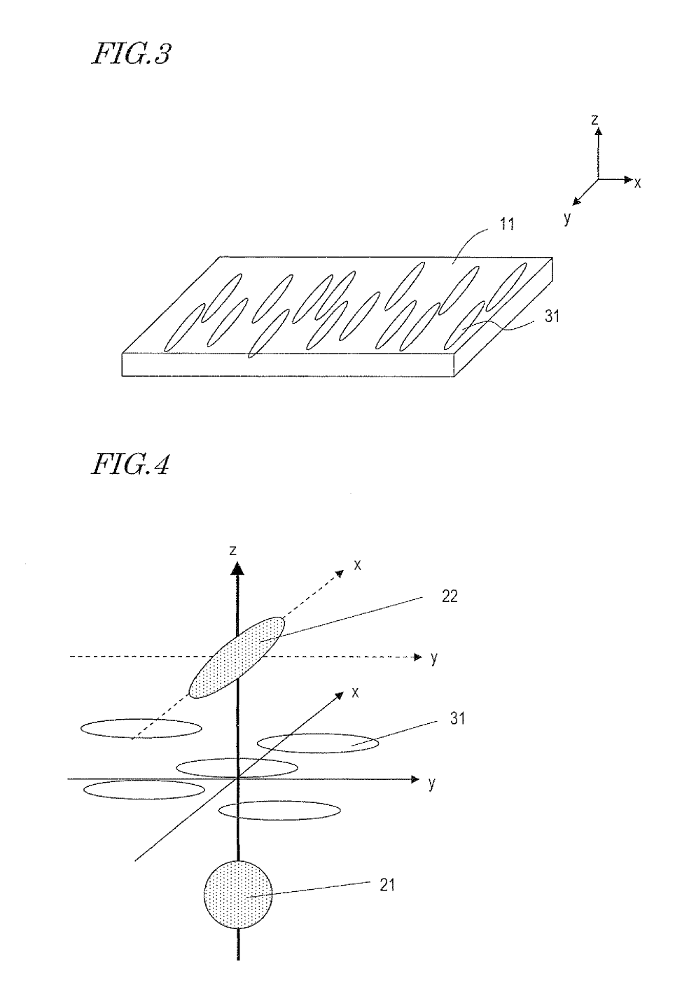

FIG. 4 is a diagram showing how the anisotropic diffusion particles (filler needles) 31 may diffuse light. When isotropic light 21 is incident on the filler needles 31, the light 21 is diffused by the filler needles 31. The filler needles 31 have characteristics such that they do not much diffuse the light 21 along their major axis direction (y direction), but greatly diffuse the light 21 along their minor axis direction (x direction). Therefore, the light 22 transmitted through the filler needles 31 is anisotropic diffused light which is greatly diffuse along the x direction but not much diffused along the y direction.

Note that the anisotropic diffusion particles (filler needles) 31 may be disposed directly in the light guide plate 12. In the description of the embodiment of the present invention, the expression that the anisotropic diffusion particles 31 is disposed on the light guide plate will also be used of a construction in which the anisotropic diffusion plate 11 is provided on the light guide plate 12.

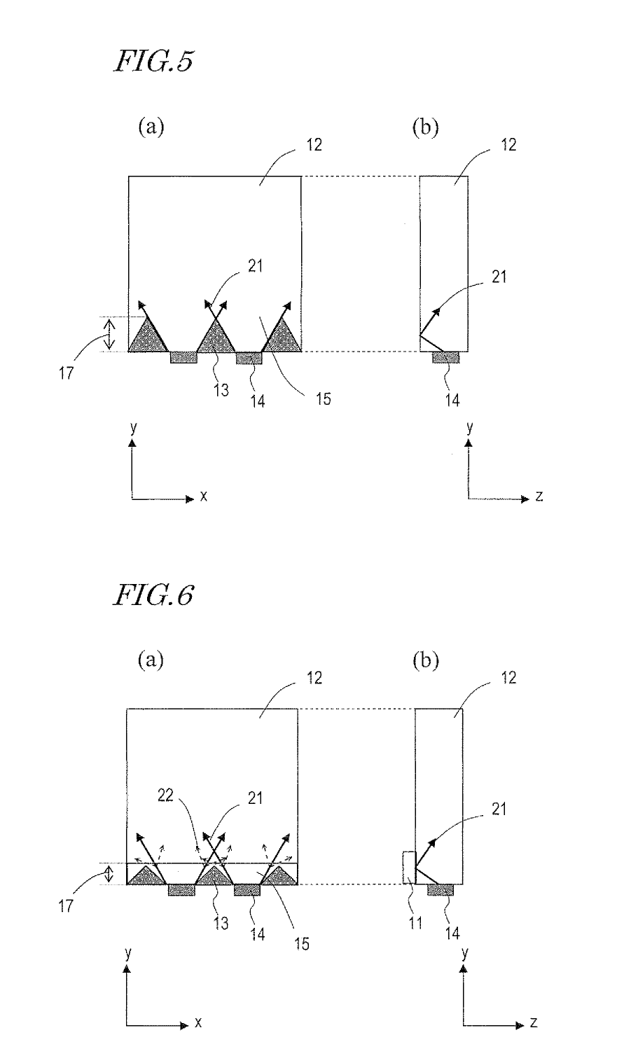

FIG. 5 shows how light may propagate through a light guide plate 12 in which no anisotropic diffusion particles (filler needles) 31 are disposed, whereas FIG. 6 shows how light may propagate through a light guide plate 12 in which the anisotropic diffusion particles (filler needles) 31 are disposed. FIG. 5(a) and FIG. 6(a) are plan views of the light guide plate 12, whereas FIG. 5(b) and FIG. 6(b) are cross-sectional views of the light guide plate 12.

With reference to FIG. 5(a), the isotropic light 21 which has not been diffused by the anisotropic diffusion particles 31 has a small degree of diffusion along the x direction, thus creating broad dark portions 13. This broadens the regions in which the dark portions 13 and the bright portions 15 are mixedly present, and if these mixed regions reach the displaying region, eyeball-like unevenness will be visually recognized in the displaying region. Increasing the length of the runway 17 in order to prevent eyeball-like unevenness from being visually recognized will result in a problem of increasing the size of the module.

On the other hand, with reference to FIG. 6(a), anisotropic light 22 which has been diffused by the anisotropic diffusion particles 31 has a large degree of diffusion along the x direction and expands broadly along the x direction, and therefore the dark portions 13 have small areas. Since the regions in which the dark portions 13 and the bright portions 15 are mixedly present can be reduced in area (i.e., eyeball-like unevenness can be reduced), it becomes possible to prevent eyeball-like unevenness from being visually recognized in the displaying region, thus allowing for an improved appearance. Moreover, since the runway 17 can be kept short, it is possible to downsize the module. In particular, the frame portion of the liquid crystal display device can be downsized.

Note at, since the anisotropic diffusion particles 31 cause anisotropic diffusion of the light 21, there is little diffusion along the z direction, and as shown in FIG. 5(b) and FIG. 6(b), there is hardly any optical path difference along the z direction.

Moreover, by disposing the anisotropic diffusion particles 31 in the light guide plate 12 so as not to reach the active region (displaying region), it becomes possible to prevent diffusion of light in the active region. This makes it possible to improve the appearance at the ends of the displaying region, while maintaining the narrow directivity characteristics of light suitable for microlenses.

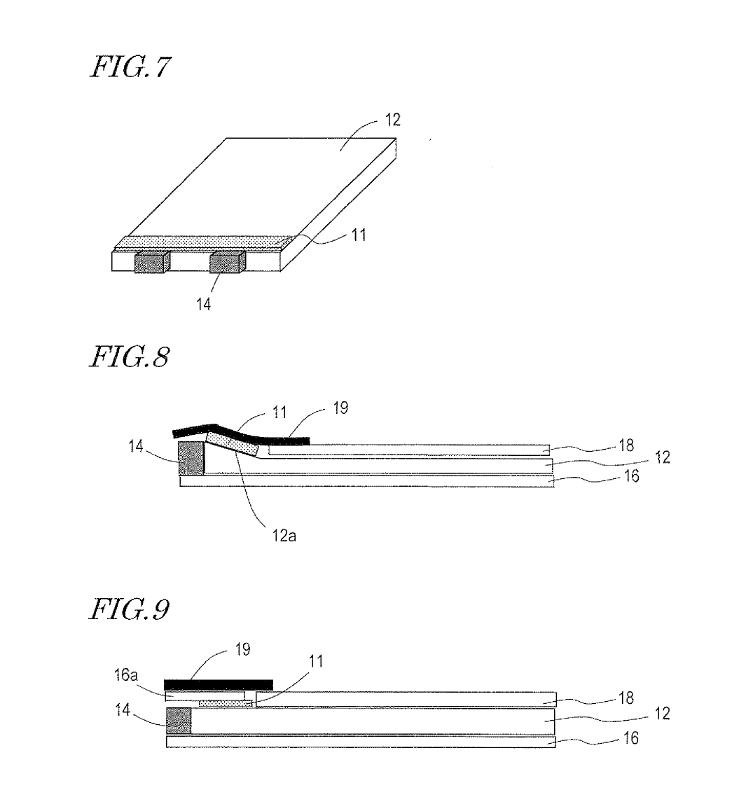

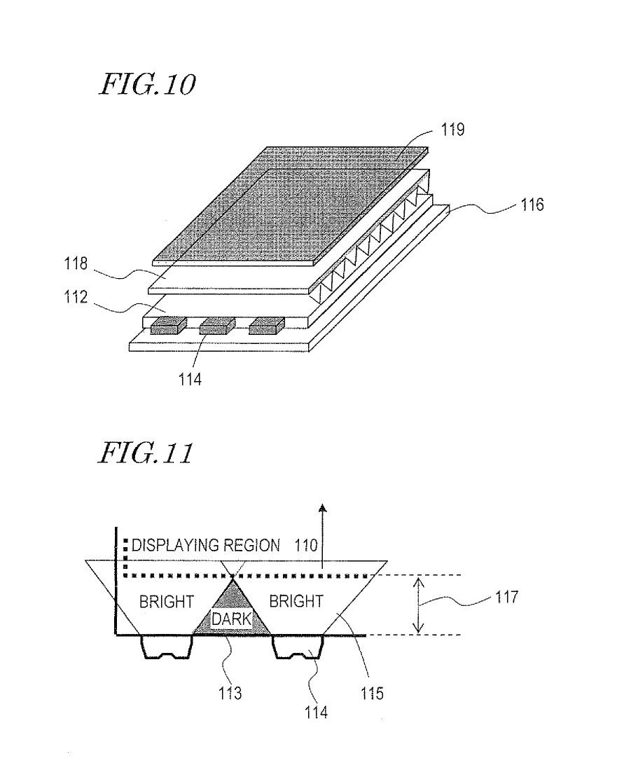

Moreover, as shown in FIG. 7, the anisotropic diffusion plate 11 may be disposed on the outgoing face side (viewer side) of the light guide plate 12. Eyeball-like unevenness can be also reduced with such a construction. However, it has been found that the luminance at the ends of the displaying region is relatively likely to decrease with the construction shown in FIG. 7. However, depending on the type of the light sources (e.g., linear sources of light), a reflector is disposed also on the outgoing face side of the light guide plate 12. In this case, by providing an anisotropic diffusion plate 11 also between the reflector on the outgoing face side and the light guide plate 12 (i.e., combining the construction of FIG. 2(b) and the construction of FIG. 7), it is possible to reduce eyeball-like unevenness while minimizing the decrease in luminance.

Next, with reference to FIG. 8, an anisotropic diffusion plate 11 disposed on a light guide plate 12 having a tapered portion will be described. With the ongoing decrease in the thickness of a module, there is a technique of reducing the thickness of the light guide plate 12 in the active region by employing a light guide plate 12 whose cross section has a partial trumpet shape (tapered). The thickness of the light guide plate 12 at the LED 14 end is thicker than the thickness of the light guide plate 12 at a position corresponding to the active region (image displaying region), and thus the light guide plate 12 has a tapered portion 12a whose thickness becomes gradually thinner from the LED 14 end toward the position corresponding to the active region. However, when a reverse prism type is adopted for this construction, outgoing light from the LEDs 14 will directly leak from the tapered portion 12a, thus resulting in a deteriorated appearance. In order to alleviate this problem, the tapered portion 12a is shaded by a light-shielding sheet (black tape) 19. However, the light-shielding sheet 19 only prevents leaking of light, and has no effect on the eyeball-like unevenness. Therefore, by disposing the anisotropic diffusion plate 11 on the tapered portion 12a of the light guide plate 12 as such, eyeball-like unevenness can be reduced, thus providing for an improved appearance.

Next, with reference to FIG. 9, an anisotropic diffusion plate 11 disposed on a light guide plate 12 adjoining unpackaged LEDs such as linear sources of light will be described. For unpackaged LEDs 14 which are shown in FIG. 9, a structure is adopted in which reflectors 16 and 16a are used to sandwich the LEDs 14 from above and below. By disposing the anisotropic diffusion plate 11 between the reflectors 16 and/or 16a and the light guide plate 12 having such a structure, eyeball-like unevenness can be reduced, and the appearance can be improved.

Note that diffusibility of anisotropic diffusion can be discussed in terms of haze values. The haze value is desirably 30% to 70%. If it is 30%, the effect of reducing eyeball-like unevenness is small, but the decrease in luminance can be suppressed. If it is 70%, the effect of reducing eyeball-like unevenness is large, but the luminance is decreased at a large rate.

Although the above-described embodiment illustrates a reverse prism type illuminator as an example, the present invention is not limited thereto. The present invention is also applicable to an illuminator of a method in which one or more BEF (Brightness Enhancement Film) are used (e.g. BEF-BEF method), for example.

### INDUSTRIAL APPLICABILITY

The present invention is particularly useful in the technological fields of liquid crystal display devices and illuminators to be mounted in liquid crystal display devices.

1. An illuminator comprising:
a plurality of light sources for emitting light;
a light guide plate for propagating the emitted light; and
anisotropic diffusion particles disposed on at least a portion of the light guide plate closer to the light sources, the anisotropic diffusion particles diffusing light propagating through the light guide plate, wherein
regarding in-plane directions of the light guide plate, the anisotropic diffusion particles diffuses the light more along a direction which is parallel to an arraying direction of the plurality of light sources than along a perpendicular direction thereto.

2. The illuminator of claim 1, wherein the anisotropic diffusion particles are disposed in at least a portion of a region extending from a light-source end of the light guide plate to a position corresponding to an image displaying region.

3. The illuminator of claim 1, further comprising a reflector for reflecting light propagating through the light guide plate, wherein
the anisotropic diffusion particles are disposed on a face of the light guide plate facing the reflector.

4. The illuminator of claim 1, wherein the anisotropic diffusion particles are disposed on an outgoing face side of the light guide plate.

5. The illuminator of claim 1, wherein,
a light-source end of the light guide plate has a thickness which is thicker than a thickness of a position of the light guide plate corresponding to an image displaying region;
the light guide plate has a tapered portion whose thickness becomes gradually thinner from the light-source end toward the position corresponding to the image displaying region; and
the anisotropic diffusion particles are disposed on the tapered portion.

6. The illuminator of claim 1, further comprising an anisotropic diffusion plate disposed in a portion of the light guide plate closer to the light sources, wherein
the anisotropic diffusion particles are contained in the anisotropic diffusion plate.

7. The illuminator of claim 1, wherein the illuminator is a reverse prism type backlight.

8. A liquid crystal display device comprising:
the illuminator of claim 1; and
a liquid crystal panel having a pair of substrates and a liquid crystal layer interposed between the pair of substrates.

9. The liquid crystal display device of claim 8, further comprising a plurality of microlenses provided between the liquid crystal panel and the illuminator.
